(19) United States
(12) Patent Application Publication
(10) Pub. No.: US 2024/0416226 A1
(43) Pub. Date: Dec. 19, 2024

(54) Programmable Hand-Held Video Gaming Controller System

(71) Applicant: John Elias Fahmie, Lecanto, FL (US)

(72) Inventor: John Elias Fahmie, Lecanto, FL (US)

(21) Appl. No.: 18/820,743

(22) Filed: Aug. 30, 2024

Related U.S. Application Data
(63) Continuation-in-part of application No. 17/725,252, filed on Apr. 20, 2022.
(63) Continuation-in-part of application No. 17/192,221, filed on Mar. 4, 2021, now Pat. No. 11,338,198.
(63) Continuation-in-part of application No. 16/699,253, filed on Nov. 29, 2019, now Pat. No. 10,974,133.
(63) Continuation-in-part of application No. 16/433,177, filed on Jun. 6, 2019, now Pat. No. 10,543,424.

(51) Int. Cl. A63F 13/24

(52) U.S. Cl. CPC A63F 13/24

(57) ABSTRACT

A gaming platform including a hand-held video gaming controller in electrical communication with an integrated foot-operated video gaming controller. The hand-held video gaming controller including at least one game function activation switch, the at least one game function activation switch operating a game function. The hand-held video gaming controller further includes a multiplatform activation switch. The integrated foot-operated video gaming controller including at least one game function activation switch configured to control at least one game function when the multi-platform activation switch on the hand-held video gaming controller is activated.

### FIELD

The present disclosure relates to hand-held video gaming controllers, and more specifically, to a mechanism for utilizing an integrated foot-operated video gaming controller along with or in lieu of the traditional hand operations in a video gaming controller in order to simplify the hand commands, improve a gamer's performance, and increase the overall level of enjoyment and realistic experience for the user.

### BACKGROUND

Currently “traditional” hand-held video gaming controllers can have more than a “dozen” buttons and “two” joysticks to operate all the commands needed with most video games, of which generally “ten” buttons and both “joysticks” are operated with just your thumbs, limiting a player's ability to just “two” commands at the same time on these buttons and/or joysticks.

The “traditional” layout on most video gaming controller's “group” many of the buttons close to each other; which can result in pressing the wrong button, especially when under pressure. The ability to separate the functions of these “grouped” buttons could reduce pressing the wrong button by mistake.

By integrating a platform that couples different “traditional hand held gaming controller” functions to a separate apparatus, would allow a player to operate “traditional handheld controller” commands such as examples: gas, brake, clutch while operating automobiles; rudders and flaps when operating aircraft, or even track controls on tanks and other machines, with the use of their feet, providing a more realistic experience and potentially “doubling” the number of traditionally “thumb-operated” commands that could be made at the same time, giving a player a clear advantage over their opponent.

### SUMMARY

The present disclosure is a method and system for utilizing foot-operated game function activation switches along with traditional hand-operations in a video gaming controller; in one embodiment, a player can ‘share’ at least one traditional hand-held video controller function with at least one foot-operated game function activation switch on the integrated foot-operated video gaming controller platform.

In one embodiment of the present disclosure, a gaming platform is provided. The gaming platform includes a hand-held video gaming controller including at least one game activation switch, the at least one game activation switch operating a game function. The handheld video gaming controller further including a multi-platform activation switch, and an in electrical communication with the hand-held video gaming controller. The integrated foot-operated video gaming controller platform includes at least one foot-operated game function activation switch configured to control at least one game function when the multi-platform activation switch on the hand-held video gaming controller is activated.

In one embodiment of the present disclosure, a gaming platform is provided. The gaming platform includes a programmable hand-held video gaming controller including at least one game function activation area, each of the at least one game function activation areas operating a game function, each of the at least one game function activation areas further comprising a function control transfer switch, and an in electrical communication with the programmable handheld video gaming controller. The integrated foot-pedal gaming controller platform includes at least one foot-pedal configured to control at least one game function when a corresponding function control transfer switch on the programmable hand-held video gaming controller is activated.

In another embodiment of the present disclosure, a gaming method for sharing or transferring gaming function control between a programmable hand-held video gaming controller and an integrated foot-pedal gaming controller platform is provided. The method includes activating a function control transfer switch located on a game function activation area of the programmable hand-held video gaming controller, the activation of the function control transfer switch transferring control of the gaming function associated with the game function activation area to a corresponding foot pedal on the integrated foot-pedal gaming controller platform.

In another embodiment, a gaming platform is provided, the gaming platform including a programmable hand-held video gaming controller including at least one game function activation area, each of the at least one game function activation areas operating a game function. Each of the at least one game function activation areas further including a function control transfer switch operable to transfer control of the game function to different foot pedals on an integrated foot-pedal gaming controller platform upon successive activations of the function control transfer switch, and at least one indicator light configured to indicate which pedal on the integrated foot-pedal gaming controller platform control of the game function associated with the game function activation area has been transferred to. The gaming platform further includes an integrated foot-pedal gaming controller platform in electrical communication with the programmable hand-held video gaming controller, the integrated foot-pedal gaming controller platform including at least one foot-pedal configured to control at least one game function when a corresponding function control transfer switch on the programmable hand-held video gaming controller is activated.

In another embodiment, a gaming platform is provided, the gaming platform including a programmable hand-held video gaming controller including at least one game function activation area, each of the at least one game function activation areas operating a game function. Each of the at least one game function activation areas further including a function control transfer switch configured to the transfer control of the game function to either a left gaming shoe or a right gaming shoe as part of an integrated gaming shoe controller platform. The gaming platform further includes an integrated gaming shoe controller platform in electrical communication with the programmable hand-held video gaming controller, the integrated gaming shoe platform including at least one function activation pad configured to control at least one game function when a corresponding function control transfer switch on the programmable hand-held video gaming controller is activated.

In another embodiment, a gaming platform is provided, the gaming platform including a programmable hand-held video gaming controller including at least one game function activation area, each of the at least one game function activation areas operating a game function. Each of the at least one game function activation areas further including a function control transfer switch configured to transfer control of the game function to a control mechanism incorporated into the programmable hand-held video gaming controller that would allow a user to activate game function by rotating the programmable hand-held video gaming controller to the left or to the right.

### BRIEF DESCRIPTION OF THE DRAWINGS

FIG. 1 illustrates a top view of the programmable hand-held video gaming controller of the present disclosure;

FIG. 2 illustrates a top view of the integrated foot-pedal gaming controller platform of the present disclosure;

FIG. 3 illustrates a top view of an alternate embodiment of the programmable hand-held video gaming controller of the present disclosure.

FIG. 4 illustrates the bottom view of the dual function gaming shoe of the present disclosure.

FIG. 5 illustrates the bottom view of the quad function gaming shoe of the present disclosure.

FIG. 6 illustrates the top view of an alternate embodiment of the programmable handheld video gaming controller of the present disclosure

FIG. 7 illustrates the top view of the integrated articulating mouthpiece gaming controller and an alternate embodiment of the programmable hand-held video gaming controller of the present disclosure.

FIG. 8 illustrates the top view of the integrated pneumatic mouthpiece gaming controller of the present disclosure.

FIG. 9 illustrates the top view of the hand-held video gaming controller of the present disclosure.

FIG. 10 illustrates the top view of the integrated foot-operated video gaming controller platform of the present disclosure.

### DETAILED DESCRIPTION

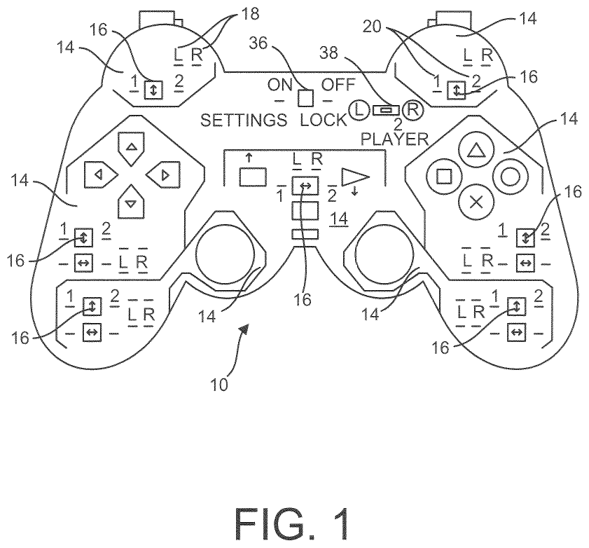

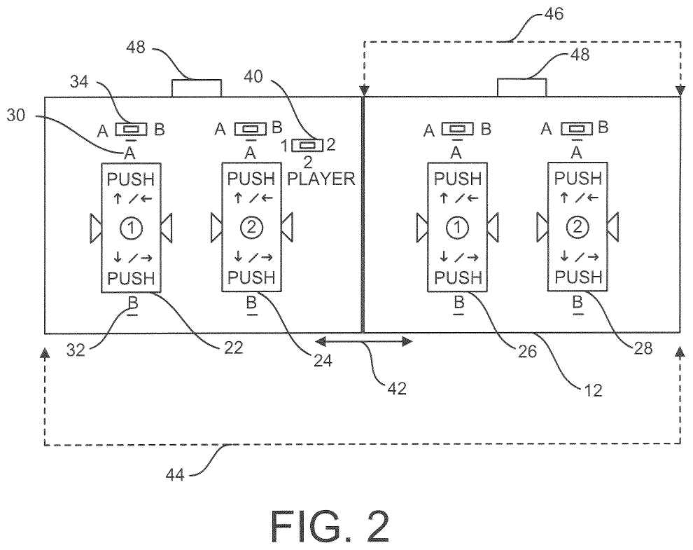

FIG. 1 illustrates an exemplary layout of the programmable hand-held video gaming controller 10 of the present disclosure. Game controller 10 is electrically coupled to an integrated foot pedal gaming controller platform 12 (see FIG. 2) either via wires or wirelessly, through communication methods commonly known in the electrical arts. In one embodiment of the present disclosure, both game controller 10 and integrated foot-pedal gaming controller platform 12 are fully operable to provide control to ‘various’ gaming features as commonly known in the art. In another embodiment of the present disclosure, both game controller 10 and integrated foot-pedal gaming controller 12 are fully operable to provide ‘specific’ gaming features as commonly known in the art. Both game controller 10 and integrated foot-pedal gaming controller platform 12 include the necessary hardware, software, memory, and electrical circuits to provide a fully-programmable video game controller module as is currently known in the art, or a non-programmable video game controller module as is currently known in the art.

Game controller 10 includes one or more game function activation areas 14, each of which includes game control buttons, switches, levers, etc., commonly known in the art to allow a user to control specific game functions. Each game function activation areas 14 also includes a game function transfer switch 16 that is configured to perform a variety of functions. The present disclosure is not limited to the exact type of gaming functions that can be performed by the activation of switch 16. Further, switch 16 can be a push button, or any other type of switch commonly known in the art.

Game controller 10 may, in certain embodiments, also include indicator lights 18 and 20. Indicator lights 18 and 20 are located in each game function activation area 14. Indicator lights 18 indicate which side of integrated foot-pedal gaming controller platform 12 control for that specific game function has been transferred to. For example, if control of the function associated with a particular game function activation area 14 is transferred to the left side of integrated foot-pedal gaming controller platform 12 then indicator light 18 will show an “L” and if the control of the game function has been transferred to the right side of the integrated foot pedal gaming controller platform 12 then indicator light 18 will show an “R”.

Similarly, indicator lights 20 indicate which pedal of integrated foot pedal gaming controller platform 12 control for that specific game function has been transferred to. For example, if control of the function associated with a particular game function activation area 14 is transferred to the first pedal of integrated foot-pedal gaming controller platform 12 then indicator light 20 will show a “1” and if the control of the game function has been transferred to the second pedal of the integrated foot-pedal gaming controller platform 12 then indicator light 20 will show an “2”. Thus, for example, if control of a particular game function has been transferred to the second pedal of the right side of integrated foot-pedal gaming controller platform 12 indicator light 18 will show an “R” and indicator light 20 will show a “2.” In this fashion, the user can easily see which pedals are not controlling this particular game function.

An exemplary methodology of how game function controls are transferred to foot pedals will now be discussed. Referring now to both FIG. 1 and FIG. 2, in one embodiment, when switch 16 located in a game function activation area 14 is activated for a first time, instead of the selected game function associated with the game controls in the function activation area 14 remaining in the control of game controller 10 as is traditional, the selected game function is transferred to a corresponding foot pedal on integrated foot-pedal gaming controller platform 12.

For example, when switch 16 is activated a first time, the gaming function that would normally be initiated by the activation of switch 16 is instead transferred to a corresponding pedal located on foot pedal gaming controller platform 12, e.g., the first pedal 22 on the left side of the integrated foot pedal gaming controller platform 12, as shown in FIG. 2. This allows the user to control this particular game function by activating the corresponding foot pedal, i.e., pedal 22 on integrated foot pedal gaming controller platform 12, rather than controlling the game function via use of game controller 10. As described above, in one embodiment, corresponding indicator lights 18 and 20 on gaming controller 10 may be illuminated to thus indicate that control of this particular game function has been transferred from game controller 10 to a corresponding foot pedal on integrated foot pedal gaming controller platform 12, for instance, the first pedal 22 on the left side of integrated foot pedal gaming controller platform 12, as shown in FIG. 2. In another embodiment, function inverter switch indicator lights 30 and 32 on integrated foot pedal gaming controller platform 12 are also illuminated to indicate to the user which foot pedal is currently controlling a game function.

In other embodiments, when switch 16 on game controller 10 is activated a second time, the game function that would normally be controlled by switch 16 is transferred to a different foot pedal, i.e., different from the foot pedal that controls the game function when switch 16 is activated for a first time. For example, when switch 16 is activated a second time, the function that would normally be activated by the actuation of switch 16 on game controller 10 is transferred to a different foot pedal on integrated foot-pedal gaming controller platform 12. For example, this foot pedal could be the second pedal 24 on the left side of the integrated foot-pedal gaming controller platform 12, as shown in FIG. 2. Again, in one embodiment, corresponding indicator lights 18 and 20 on game controller 10 and indicator lights on integrated foot-pedal gaming controller platform 12 may be illuminated to indicate that control of this particular game function has been transferred to a corresponding foot pedal on integrated foot-pedal gaming controller platform 12, for instance second pedal 24 on the left side of integrated foot-pedal gaming controller platform 12.

In another embodiment, when switch 16 is activated a third time, the function that would normally be associated with switch 16 on game controller 10 is transferred to a different foot pedal on integrated foot-pedal gaming controller platform 12, i.e., different from the foot pedal to which control of the game function was transferred when switch 16 was activated a first time and the foot pedal to which control of the game function was transferred when switch 16 was activated a second time. For example, this foot pedal could be the first pedal 26 on the right side of integrated foot-pedal gaming controller platform 12. In one embodiment, corresponding indicator lights 18 and 20 on game controller 10 and indicator lights on integrated foot-pedal gaming controller platform 12 may be illuminated to indicate that this particular game function has been transferred to a corresponding pedal on integrated foot-pedal gaming controller platform 12, for instance, the first pedal 26 on the right side of integrated foot-pedal gaming controller platform 12.

In another embodiment, when switch 16 is activated a fourth time, the function that would normally be activated by the activation of switch 16 on game controller 10 is transferred to a different foot pedal on integrated foot-pedal gaming controller platform 12, i.e., different from the foot pedal to which control of the game function was transferred when switch 16 was activated a first time, the foot pedal to which control of the game function was transferred when switch 16 was activated a second time, and the foot pedal to which control of the game function was transferred when switch 16 was activated a third time. For example, this foot pedal to which control is transferred could be the second pedal 28 on the right side of integrated foot pedal gaming controller platform 12. In one embodiment, corresponding indicator lights 18 and 20 on both game controller 10 and indicator lights on integrated foot-pedal gaming controller platform 12 may be illuminated to indicate that this particular game function has been coupled to a corresponding pedal on integrated foot-pedal gaming controller platform 12, in this instance, the second pedal 28 on the right side of integrated foot-pedal gaming controller platform 12.

In still another embodiment, when switch 16 on game controller 10 is activated a fifth time, all connections to integrated foot-pedal gaming controller platform 12 are deactivated along with corresponding indicator lights 18 and 20 on game controller 10 and integrated foot-pedal gaming controller platform 12, returning control of the function back to the hand-held game controller 10.

Note that the number and order of activations of the switch 16 given above to transfer control of a game function from game controller 10 to a specific pedal on integrated foot-pedal gaming controller platform 12 is exemplary only. Thus, the present disclosure is not limited to the exact number of switch 16 activations or the order of switch 16 activations indicated above. Thus, for example, a first activation of switch 16 may transfer control to, for example, the first pedal 26 on the right side of integrated foot-pedal gaming controller platform 12. Further, activating switch 16 may result in different operations. For example, in one embodiment, if switch 16 is activated for a first time, instead of the game function remaining in the control of game controller 10, the selected function is coupled to a foot pedal on the integrated foot-pedal gaming control platform 12. If switch 16 is pressed two times, control of that gaming function is moved to a different pedal on the integrated foot pedal gaming platform 12. However, if switch 16 is activated three times, the connection of the indicated function to the pedals of the integrated foot-pedal gaming controller platform 12 and push button and indicators is deactivated, returning control of the function solely to hand-held game controller 10.

The term “transferring” as used herein may mean that total control of a game function is transferred from game controller 10 to integrated foot-pedal gaming controller platform 12 and control of that game function in the hand-held game controller 10 is deactivated, or it may mean that control of this game function is shared between both hand-held game controller 10 and integrated foot-pedal gaming controller platform 12. This latter embodiment may be advantageous for example “in the heat of battle” during gaming when gamers may wish to use both the handheld game controller 10 and foot pedals on the integrated foot-pedal gaming controller platform 12 without having to think about which apparatus is currently controlling the game function.

Referring again to FIG. 1, when, for example, the first pedal 22 on the left side of integrated foot-pedal gaming controller platform 12 is being used for certain game function control, the switch 16 associated with the selected function and the corresponding indicator light 18 will illuminate to show an “L” and indicator light 20 will illuminate to show a “1” on the programmable hand-held video gaming controller, Further, in another embodiment, a corresponding upright pedal function indicator light “A” 30 or an inverter pedal function indicator light “B” 32, will illuminate on the corresponding pedal (i.e., 22) on integrated foot-pedal gaming controller platform 12, depending on which setting the pedal function inverter switch 34 is set to. This, advantageously, alerts players as to which setting the pedal function inverter switch 34 is set to, either upright function or inverted function. This feature allows the gamer to access two different gaming functions per foot pedal.

An exemplary use of the pedal function inverter switch 34 is, in one embodiment, each time a player activates game function transfer switch 16 on programmable hand-held video gaming controller 10, it transfers two functions to a rocker pedal, one at the top of the pedal and one at the bottom of the pedal. With pedal function inverter switch 34, the player can choose to reverse those two functions if they wish. For example, if the player transferred the gas and brake functions of an automobile-based video game to a rocker pedal and the brake function was at the top of the pedal and the gas function was at the bottom of the pedal, a player may choose to reverse these two functions so the gas function is at the top of the rocker pedal and the brake function is at the bottom of the pedal. This would allow any control function on gaming controller 10 to be transferred to (or coupled to) the top or the bottom of any rocker pedal, thereby doubling a player's options.

When, for example, the second pedal 24 on the left side of the integrated foot-pedal gaming controller platform 12 is being used for certain game function control, the push button for the selected function will be illuminated and the corresponding indicator 18 will illuminate with an “L” and corresponding indicator 20 will illuminate with a “2” on the programmable hand-held video gaming controller. Also, the corresponding “A” 30 or “B” 32 indicator lights for pedal 24 (indicated as “2” on the hand-held game controller because it is the second foot pedal) will illuminate on the integrated foot-pedal gaming controller platform 12, alerting a player to which setting the pedal function inverter switch 34 is set to, i.e., either upright function or inverted function. Thus, for example, when control of a game function has been given to the second pedal 28 on the right side of the integrated foot-pedal gaming controller platform 12, the push button for the selected function in the game function activation area illuminates and the corresponding indicator 18 will show an “R” and indicator 20 will show a 2 In one embodiment, function inverter switch 34 indicator light “A” 30 or “B” 32 will be also illuminated on the integrated foot-pedal gaming platform 12. In this fashion, the indicator lights fully alert the gamer as to which pedals have taken over, or are sharing control, each game function.

In one embodiment, hand-held game controller 10 may include an on/off push button switch 36 that activates and deactivates a setting lock on all programmable hand-held video gaming controller functions and illuminates corresponding on/off indicator lights. In one embodiment, on/off push button switch 36 requires players to hold the switch 36 for a predetermined amount of time, e.g., two seconds, to switch on or off the function and to prevent unwanted changes to the settings.

In one embodiment, game controller 10 includes a two-player selector switch 38 that allows two players, each equipped with a programmable hand-held video gaming controller 10, to choose either left side pedals (either the first pedal and/or the second pedal on the left side) or right-side pedals (either the first pedal and/or the second pedal on the right side) on the integrated foot-pedal gaming controller platform 12. The use of the player selector switches 38 thus limits the programmable hand-held video gaming controller functions to either the selected left side pedals “1” and “2” or right-side pedals “1” and “2” of the integrated foot-pedal gaming controller platform 12 thereby allowing two players to play side-by-side with the use of two pedals each.

As discussed herein, in certain embodiments, the programmable hand-held video gaming controller 10 may transfer the activated function to the integrated foot-pedal controller platform 12 or instead of transferring game function control to the foot pedals, control can be shared between game controller 10 and the foot pedals of integrated foot-pedal controller platform 12.

Referring to FIG. 2, in one embodiment, one or more of the pedals of integrated foot-pedal gaming controller platform 12 may be dual operation rocker pedals that allow a player to rock the pedal forward or backwards to perform two separate programmable hand-held video gaming controller functions with one pedal. Pedal function inverter switch 34 allows a player to reverse pedal function from upright pedal function to inverted pedal function. Pedal function indicator light “A” 30 indicates the upright foot pedal function while pedal function indicator light “B” 32 indicates the inverted foot pedal function. Two-player indicator light 18 on programmable hand-held video gaming controller 10 will illuminate an “L” when a player chooses to use the left side pedals ‘1” 22 and “2” 24 on the integrated foot-pedal gaming platform 12. Two-player indicator light 18 will illuminate “R” when a player chooses to use the right-side pedals “1” 26 and 2 28 on the integrated foot-pedal gaming controller platform 12. In one embodiment, when a player chooses the two-player indicator light “L” or the two-player indicator light “R” setting on the programmable hand-held video gaming controller 10 it will also activate and illuminate the two-player switch 40 on the integrated foot-pedal gaming controller platform 12, thus alerting the player that the two-player switch has been activated on the programmable hand-held video gaming controller 10.

In other embodiments, variations of the integrated foot-pedal gaming controller platform 12 may include single function pedals, dual operation rocker pedals, quad-operation (4way) rocker pedals or combinations of two or more. The 4-way rocker pedal can be rocked forward or backward or side to side to allow a player to activate four different functions with a single pedal like a typical joystick. Other variations of the integrated foot-pedal gaming controller platform 12 may be modified to fit into a gaming chair, in place of an adjustable hinged connecting frame that forms the integrated foot-pedal gaming controller platform 12.

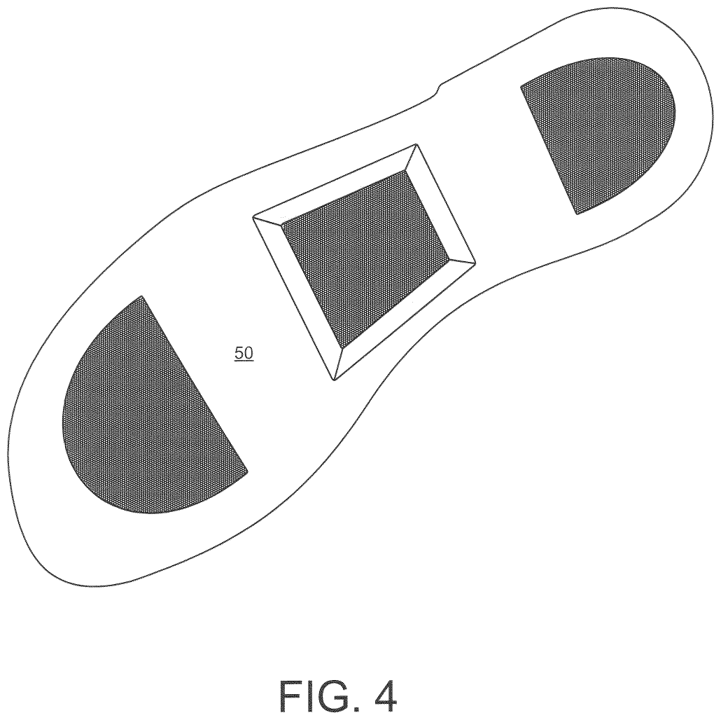

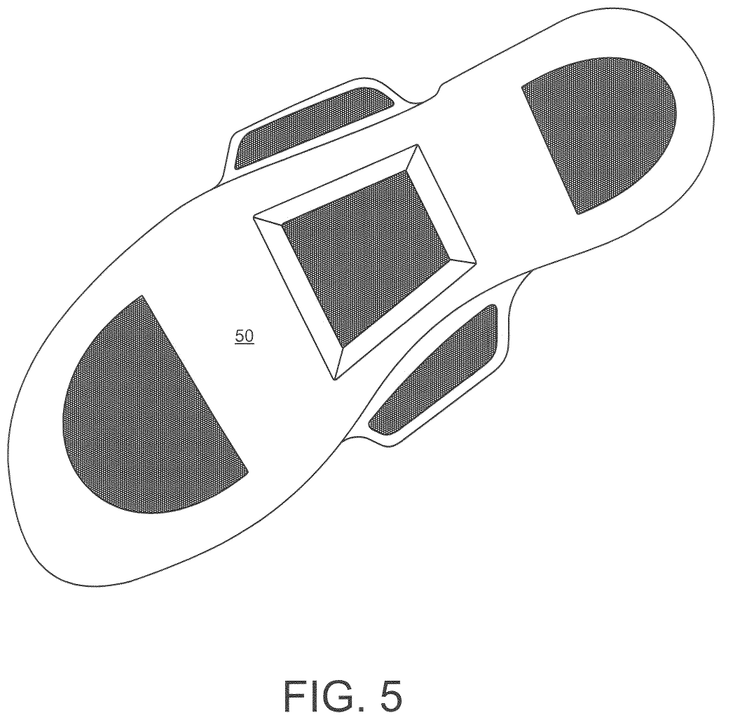

In another embodiment, variations of the integrated foot-pedal gaming controller platform 12, may be incorporated into footwear. For example, in one embodiment; rather than having rocker pedals mounted on a deck platform, a “dual-function” rocker pedal mechanism may be incorporated in the construction of a gaming shoe 50. as shown in FIG. 4. This allows a player to control two traditional hand-held video gaming controller functions by resting the sole of the shoe 50 on a firm surface and rocking their foot forward or backward. Further, a quad function rocker pedal mechanism may be incorporated into the gaming shoe 50, as shown in FIG. 5. This allows the player to rock their foot forward, backward and side to side to imitate the functions of a traditional joystick.

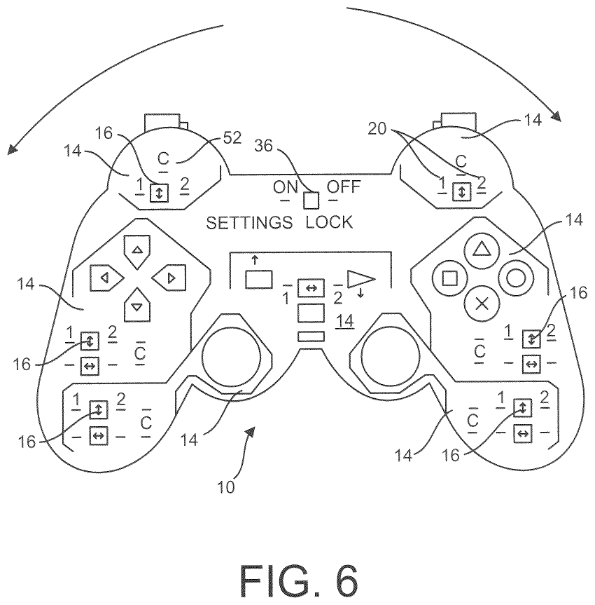

In another embodiment, variations of the integrated foot-pedal gaming controller platform 12, may be incorporated into the programmable hand-held video gaming controller itself. For example, in one embodiment; rather than having a rocker pedal mounted on a deck platform, a “dual function” rocker mechanism may be incorporated into the construction of a programmable hand-held video gaming controller 10. as shown in FIG. 6. This allows a player to control two traditional hand-held video gaming controller functions by “rotating” the programmable hand-held video gaming controller to the “left” or to the “right”. Indicator light 52 as shown in FIG. 6 alerts the player that control function has been transferred to the dual function rocker mechanism in the programmable hand-held video gaming controller.

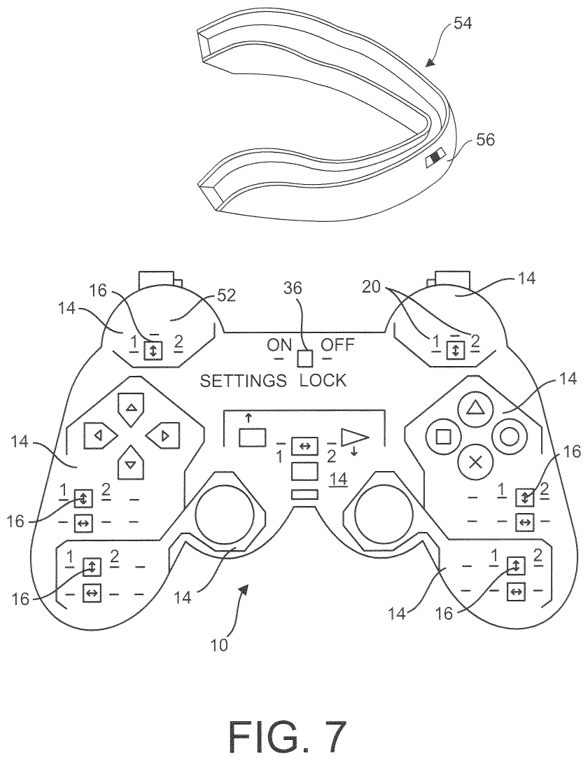

In another embodiment, variations of the integrated foot-pedal gaming controller platform 12, may be incorporated into the integrated articulating mouthpiece gaming controller 54 as shown in FIG. 7. When game function transfer switch 16 is activated, game function associated with the game function activation area 14 are transferred to the integrated articulating mouthpiece gaming controller 54 allowing user to activate at least one game function associated with the game function activation area 14 by applying pressure with his or her jaw. Furthermore, different embodiments of the integrated articulating mouthpiece gaming controller will include a game function inverter switch 56 allowing players to choose between upright mouthpiece function and inverted mouthpiece function which provides more setting options.

Integrated foot-pedal gaming controller platform 12 may also include an adjustable hinged connecting frame 42 that supports the integrated foot-pedal gaming controller platform 12, adjusts for pitch, and is configured to fold for easy transportation.

In one embodiment, integrated foot pedal gaming controller platform 12 can be comprised of two separate panels (indicated by dashed lines 44) that can slide apart on rails thus extending the length of integrated foot-pedal gaming controller platform 12 for two-player action. Alternately, integrated foot pedal gaming controller platform 12 can be comprised of only one panel with two pedals as indicated by the dashed lines 46. Handles 48 may be positioned atop integrated foot-pedal gaming controller platform 12 or a single handle 48 may be positioned atop integrated foot-pedal gaming controller 12 to allow for easy transportation.

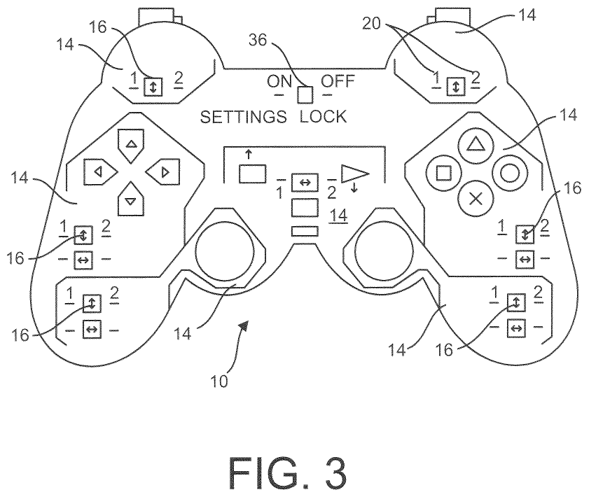

FIG. 3 illustrates an exemplary layout of an alternate programmable hand-held video gaming controller 10 of the present disclosure. The game controller 10 illustrated in FIG. 3 is similar to the game controller 10 shown in FIG. 1 except that the game controller 10 in FIG. 3 is for use with a two-pedal integrated foot-pedal gaming controller platform 12. A seen, indicator lights 20 can illuminate as either a “1” or a “2” to identify which foot pedal on integrated foot-pedal gaming controller platform 12 has been transferred (or is sharing) control of that particular gaming function.

In one embodiment, a dual function rocker mechanism can be incorporated into the construction of the programmable hand-held video gaming controller itself; allowing a player to activate a function control transfer switch located on a game function activation area of the programmable hand-held video gaming controller; the activation of the function control transfer switch transferring control of the game function associated with the game function activation area to corresponding dual function rocker mechanism contained inside the programmable hand-held video gaming controller, allowing the game function to be activated by rotating the programmable hand-held video gaming controller to the “left” or the “right”; illumination of the function control transfer switch will alert the player that the dual function rocker mechanism in the programmable hand-held video game controller has been activated and indicator lights C 52 indicates which gaming functions on the hand-held video gaming controller has been transferred; and transferring control of the game function associated with the function control transfer switch to the dual function rocker mechanism contained within the programmable hand-held video gaming controller while maintaining control of the game function on the programmable hand-held video gaming controller, thereby allowing the game function to be shared between the programmable hand-held video gaming controller buttons or joysticks and by rotating the programmable hand-held video gaming controller to the “left” or to the “right”.

In another embodiment, a dual function or quad function rocker mechanism can be incorporated into the construction of an ‘integrated articulating mouthpiece gaming controller’ 54; allowing a player to activate a function control transfer switch 16 located on a game function activation area 14 of the programmable hand-held video game controller 10; the activation of the function control transfer switch 16 transferring control of the game function associated with the game function activation area 14 to an integrated articulating mouthpiece gaming controller 54, while maintaining control of game function, therefore allowing the hand-held video game controller 10 and the integrated articulating mouthpiece gaming controller 54 to share control of the at least one game function, the at least one game function transferred to the integrated articulating mouthpiece gaming controller 54 to be activated by the user applying pressure with his or her jaw; illumination of the function control transfer switch 16, and accompanying indicator light 52 will alert the player that the integrated articulating mouthpiece gaming controller 54 has been activated.

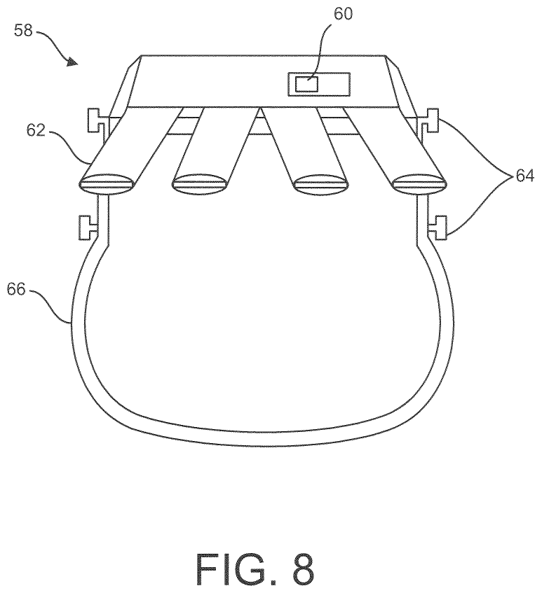

Certain embodiments of the programmable hand-held video gaming controller 10 will be configured to electrically communicate with multiple integrated gaming controller platforms, for example; a player may choose to activate a pedal on the integrated foot-pedal gaming controller platform 12 and an activation tube 62 (SEE FIG. 8) on the pneumatic mouthpiece gaming controller 58 at the same time, allowing the player to use the programmable hand-held video gaming controller 10, integrated foot-pedal gaming controller platform 12 and an integrated pneumatic mouthpiece gaming controller platform 58 simultaneously. For example, a player activates a function control transfer switch 16 on the programmable hand-held video gaming controller 10 transferring control of the game function associated with the game function activation area 14 to an integrated foot-pedal gaming controller platform 12 or integrated gaming shoe platform 50, while also activating another function control transfer switch 16 transferring control of the game function associated with the game function activation area 14 to an integrated articulating mouthpiece gaming controller 54 or integrated pneumatic mouthpiece gaming controller 58 allowing a skilled player to use all three gaming controllers at the same time.

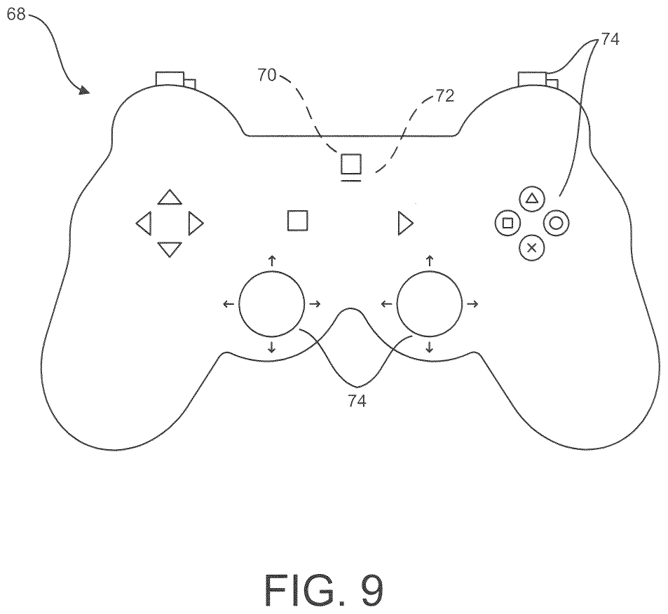

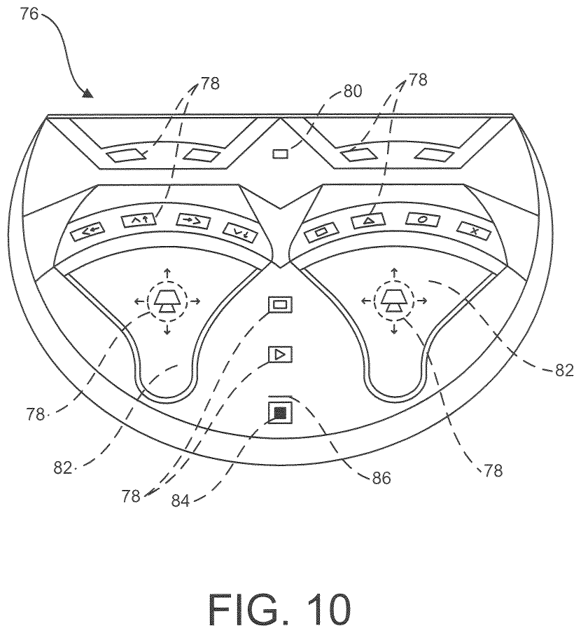

FIG. 9 illustrates an exemplary layout of the hand-held video gaming controller 68 of the present disclosure. Game controller 68 is in electrical communication with integrated foot-operated video gaming controller platform 76 (see FIG. 10) either via wired or wirelessly, through communication methods commonly known in the electrical arts. In one embodiment of the present disclosure, both game controller 68 and integrated foot-operated video gaming controller platform 76 are fully operable to provide ‘specific’ gaming features as commonly known in the art. Both game controller 68 and integrated foot-operated video gaming controller platform 76 include the necessary hardware, software, memory and electrical circuits to provide a fully operable video game controller module as is currently known in the art. In one embodiment, game controller 68 includes at least one game function activation switch 74, activation switches can be buttons, levers etc., commonly known in the art, to allow a user to control specific game functions. Game controller 68 may also include a ‘multi-platform’ activation switch 70. (see FIG. 9). In certain embodiments, game controller 68 may, also include an indicator light 72. Indicator light 72 indicates that the multi-platform activation switch 70 has been activated, electrically coupling game controller 68 to the integrated foot-operated video gaming controller platform 76, allowing a user to activate game functions with either gaming controller.

FIG. 10 illustrates an exemplary layout of the integrated foot-operated video gaming controller platform 76. In one embodiment, at least one foot-operated activation switch 78 on the integrated foot-operated video gaming controller platform 76 in electrical communication with the hand-held video gaming controller 68 (see FIG. 9) is configured to ‘share’ control of a ‘specific’ game function when the multi-platform activation switch 70 on the hand-held video gaming controller 68 is activated, allowing user to activate game functions from either controller. For example, when the multi-platform activation switch 70 on the hand-held video gaming controller 68 is activated, the game functions associated with joystick 74 on the hand-held video gaming controller 68, operated with the users left thumb is coupled to left-foot operated joystick 78 on the integrated foot-operated video gaming controller platform 76, allowing user to perform game function activation associated with the joystick 74 on the left side on the hand-held video gaming controller 68 with his left foot. In another example, when the multi-platform activation switch 70 on the hand-held video gaming controller 68 is activated, game functions associated with the at least one game function activation switches 74 operated with users right thumb or fingers is coupled to a foot-operated game function activation switch 78 on the right side of the integrated foot-operated video gaming controller platform 76 allowing user to activate game function associated with users right hand with his right foot also. In another embodiment of the integrated foot-operated video gaming controller platform 76, the left foot-operated joystick 78 and the right foot-operated joystick 78 are contained in a recessed ‘foot-operated joystick activation area’ 82 (refer to FIG. 10) intended to keep a user's foot in optimal placement for operation of game function activation switches 78 and foot-operated joystick 78. In another embodiment, integrated foot-operated video gaming controller platform 76 may contain a game function inverter switch 84 (see FIG. 10) configured to ‘swap’ left foot-operated game function activation switches 78, with right foot-operated game function activation switches 78. For example, when the multi-platform activation switch 70 on the hand-held video gaming controller 68 is activated, game function associated with game function activation switches 74 operated with a user's left thumb or fingers are coupled to game function activation switches 78 on the integrated foot-operated video gaming controller platform 76 that are operated with a user's left foot, while at the same time coupling game function activation switches 74 operated with a user's right thumb or fingers to game function activation switches 78 on the right side of the integrated foot-operated video gaming controller platform 76. By activating the game function inverter switch 84 on the integrated foot-operated video gaming controller platform 76, game function activation switches 74 associated with a user's left thumb or fingers on the hand-held video gaming controller 68, would be coupled to game function activation switches 78 on the right side of the integrated foot-operated video gaming controller platform 76; therefore, allowing user to activate a specific game function with either his left thumb or fingers or his right foot, and game function activation associated with a game function activation switch 74 configured to be operated with a user's right thumb or fingers would be coupled to foot-operated game function activation switches 78 configured to be operated with a user's left foot, further allowing a user to activate a ‘specific’ game function with either there right thumb or fingers or there left foot, adding versatility and increasing a user's options. Integrated foot-operated video gaming controller platform 76 may, in certain embodiments, include indicator lights 80 and 86 (refer to FIG. 10). Indicator light 80 is configured to alert user that the multi-platform activation switch 70 on the hand-held video gaming controller 68 has been activated, coupling game function activation switches 78 on the integrated foot-operated video gaming controller platform 76 to game function activation switches 74 on the hand-held video gaming controller 68. Indicator light 86, in certain embodiments, is configured to alert user that the game function activation inverter switch 84 on the integrated foot-operated video gaming controller platform 76 is set to inverted game function activation, therefore ‘swapping’ left foot-operated game function activation with right foot-operated game function activation. In certain embodiments of the integrated foot-operated video gaming controller platform 76 at least one foot-operated game function activation switch 78 is configured to be activated by either the left foot or the right foot.

Many different embodiments have been disclosed herein, in connection with the above description and the drawings. It will be understood that it would be unduly repetitious and obfuscating to literally describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A gaming platform, configured for use with Mobile gaming, PC gaming, and Console gaming comprising:
a hand-held video gaming controller comprising:
at least one game function activation switch, each of the at least one game function activation switch operating a game function and further includes a multi-platform activation switch; an integrated foot-operated gaming controller platform in electrical communication with the hand-held video gaming controller, the integrated foot-operated gaming controller platform comprising:
at least one foot-operated game function activation switch configured to ‘share’ control of at least one game function on the hand-held video gaming controller when the multiplatform activation switch on the hand-held video gaming controller is activated, and includes a function inverter switch that allows a user to ‘swap’ left foot-operated game function activation switches with right foot-operated activation switches; the hand-held video gaming controller and the integrated foot-operated video gaming controller may further include at least one indicator light configured to alert the user that the multi-platform activation switch on the hand-held video gaming controller has been activated or alert the user that the function inverter switch on the integrated foot-operated video gaming controller has been activated.

2. The gaming platform of claim 1, wherein the hand-held video gaming controller and the integrated foot-operated video gaming controller are configured to ‘share’ control of specific video game functions.

3. The gaming platform of claim 1 wherein the multi-platform activation switch is configured to ‘couple’ the at least one game function activation switch on the hand-held video gaming controller to the at least one foot-operated game function activation switch on the integrated foot-operated video gaming controller.

4. The gaming platform of claim 1, wherein multi-platform activation indicator lights are configured to alert user that multiple video gaming controllers are in electrical communication.

5. The gaming platform of claim 1, wherein the inverted game function activation indicator light is configured to alert user that left foot-operated game function activation switches and right foot-operated game function activation switches have been ‘swapped’.

6. The gaming platform of claim 1, wherein the inverted game function activation switch is configured to ‘swap’ left foot-operated game function activation switches with right foot-operated game function activation switches.
